(19) United States
(12) Patent Application Publication
(10) Pub. No.: US 2026/0023159 A1
(43) Pub. Date: Jan. 22, 2026

(54) CONFIGURATION FOR RADIO SENSING

(71) Applicant: Lenovo (Singapore) Pte. Limited, Singapore (SG)

(72) Inventors: Seyedomid Taghizadeh Motlagh, Oberursel (DE); Ali Ramadan Ali, Kraiburg (DE); Vijay Nangia, Woodridge, IL (US)

(73) Assignee: Lenovo (Singapore) Pte. Limited, Singapore (SG)

(21) Appl. No.: 18/997,158

(22) PCT Filed: Jul. 21, 2023
(86) PCT No.: PCT/IB2023/057470

§ 371 Date: Jan. 20, 2025

Related U.S. Application Data
(60) Provisional application No. 63/391,050, filed on Jul. 21, 2022.

(51) Int. Cl. G01S 7/41; H04B 7/06; H04L 5/00; H04W 24/08

(52) U.S. Cl. CPC G01S 7/41; H04B 7/0626; H04L 5/0048; H04W 24/08

(57) ABSTRACT

Various aspects of the present disclosure relate to methods, apparatuses, and systems that support configuration for radio sensing. For instance, implementations provide configuration of radio sensing nodes including information elements defining a priori known features of objects and/or scenarios of interest for radio sensing. Further, channel state information (CSI)-based procedures are described including CSI domain translation and CSI domain reduction. Implementations also include the introduction of conditioned reference signal received power (RSRP), reference signal reception quality (RSRQ), and reference signal strength indicator (RSSI) measurements within a configured region of a defined CSI domain as part of radio sensing.

### RELATED APPLICATION

This application claims priority to U.S. Patent Application Ser. No. 63/391,050 filed 21 Jul. 2022 entitled “CONFIGURATION FOR RADIO SENSING,” the disclosure of which is incorporated by reference herein in its entirety.

### TECHNICAL FIELD

The present disclosure relates to wireless communications, and more specifically to radio sensing.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless system designs envision the use of radio sensing for detecting environmental attributes. Radio sensing, for example, uses radio signals and/or devices to attempt to detect attributes of an ambient environment.

### SUMMARY

The present disclosure relates to methods, apparatuses, and systems that support configuration for radio sensing. For instance, implementations provide configuration of radio sensing nodes including information elements defining a priori known features of objects and/or scenarios of interest for radio sensing. Further, channel state information (CSI)-based procedures are described including CSI domain translation and CSI domain reduction. For instance, computation and/or signal processing is described to generate radio sensing results including to extract relevant portions of CSI information according to radio sensing scenarios. Implementations also include the introduction of conditioned reference signal received power (RSRP), reference signal reception quality (RSRQ), and reference signal strength indicator (RSSI) measurements within a configured region of a defined CSI domain as part of radio sensing.

Accordingly, the described techniques provide precise sensing of environmental attributes (e.g., objects present) and can reduce power consumption by providing radio sensing and context information for use in processing radio sensing data.

Some implementations of the methods and apparatuses described herein may further include receiving a first indication of one or more feature characteristics of one or more objects; receiving one or more reference signals; performing radio sensing of an environment based at least in part on the one or more reference signals and the one or more feature characteristics of the one or more objects; and transmitting a second indication based at least in part on the radio sensing.

Some implementations of the methods and apparatuses described herein may further include: receiving the first indication from a first device, and the one or more reference signals from a second, different device; receiving the first indication and the one or more reference signals from a same device; where the one or more feature characteristics of the one or more objects include at least one of: presence information for the one or more objects; location information for the one or more objects; velocity information for the one or more objects; radar cross section (RCS) for the one or more objects; types of the one or more objects; at least one of shape or posture of the one or more objects; at least one of composite or texture of the one or more objects; or a perceived CSI description at a sensing receiver node including an effect of the one or more objects, where the perceived CSI description includes at least one of a CSI domain or a CSI domain segment; where the CSI domain includes at least one of: delay domain; angular-azimuth domain; one or more of angular-elevation or zenith domain; one or more of channel or CSI periodogram; or doppler domain.

Some implementations of the methods and apparatuses described herein may further include: where the one or more feature characteristics of the one or more objects are identified in the first indication via one or more indices that correspond to a first table that includes different predefined feature values for different feature characteristics of the one or more objects; where the first table includes a first index value that corresponds to a first set of feature characteristics and a second index value that corresponds to a second set of feature characteristics, and where the first set of feature characteristics and the second set of feature characteristics include at least one common feature characteristic; where the one or more feature characteristics of the one or more objects are further identified in the first indication via one or more indices that correspond to a second table that includes predefined feature values for different feature characteristics of the one or more objects; receiving reference signal information for the one or more reference signals, the reference signal information including at least one of: one or more of a waveform type or a set of waveform-defining parameters for a waveform used to transmit the one or more reference signals; a set of resources over which the one or more reference signals are transmitted according to the waveform; one or more of a transmit beam pattern or a radio pattern over which the one or more reference signals are transmitted; a transmit power used to transmit the one or more reference signals; a sequence generation and physical-resource-mapping type used to generate the one or more reference signals; or a location of a device that transmits the one or more reference signals.

Some implementations of the methods and apparatuses described herein may further include: receiving sensing configuration information for the radio sensing, the sensing configuration information including at least one of: an indication of one or more receive spatial filters to be used for reception of the one or more reference signals; an indication of one or more known attributes of the one or more feature characteristics of the environment; or one or more types of output to be provided based on the radio sensing; and performing the radio sensing further based on the sensing configuration information; further including: receiving the first indication via a first signaling type; and receiving the sensing configuration information via a second, different signaling type; where the one or more types of output to be provided based on the radio sensing includes at least one of: one or more of quantized received reference signals or compressed reference signals; CSI measurements obtained from the received reference signals; inference of a presence of the one or more objects; estimated location of the one or more objects; estimated velocity of the one or more objects; estimated RCS of the one or more objects; estimation of one or more of type, shape, composite, or posture of the one or more objects; an indication of a sensing quality of service of the radio sensing; or combinations thereof.

Some implementations of the methods and apparatuses described herein may further include: where the one or more types of output to be provided based on the radio sensing are indicated via one or more indices that correspond to a table that includes different types of output to be provided based on radio sensing; where the one or more types of output to be provided based on the radio sensing is indicated via one or more indices that correspond to a table that includes different output values for different types of output to be provided based on radio sensing; where the CSI measurements include at least one of: a CSI domain; one or more of a segment or a margin within the CSI domain; or an operation to be performed over the CSI measurements within the indicated one or more of the segment or margin; where the CSI domain includes at least one of: delay domain; angular-azimuth domain; one or more of angular-elevation or zenith domain; one or more of channel or CSI periodogram; or doppler domain.

Some implementations of the methods and apparatuses described herein may further include: where the one or more feature characteristics of the one or more objects are identified in the first indication via one or more indices that correspond to a first table that includes different predefined feature values for different feature characteristics of the one or more objects, and where the second indication identifies output of the radio sensing via one or more indices that correspond to the first table; where the CSI measurements include, for the one or more feature characteristics, at least one of: CSI measurements on an intersection of the one or more feature characteristics; CSI measurements on a union of the one or more feature characteristics; or a combination thereof; receiving the first indication via one or more of higher layer signaling or defined physical channels of a communication network; where transmitting the second indication is based on at least one of: a set of time, frequency, and beam resources for transmission of the second indication; at least one criterion for the transmission of the second indication; or a type of information included in the second indication.

Some implementations of the methods and apparatuses described herein may further include transmitting a first indication of one or more feature characteristics of one or more objects; transmitting one or more reference signals; and receiving a second indication of a result of radio sensing performed based at least in part on the transmitted one or more reference signals.

Some implementations of the methods and apparatuses described herein may further include: where the one or more feature characteristics of the one or more objects include at least one of: presence information for the one or more objects; location information for the one or more objects; velocity information for the one or more objects; RCS for the one or more objects; types of the one or more objects; at least one of shape or posture of the one or more objects; at least one of composite or texture of the one or more objects; or a perceived CSI description at a sensing receiver node including an effect of the one or more objects, where the perceived CSI description includes at least one of a CSI domain or a CSI domain segment; where the CSI domain includes at least one of: delay domain; angular-azimuth domain; one or more of angular-elevation or zenith domain; one or more of channel or CSI periodogram; or doppler domain; where the one or more feature characteristics of the one or more objects are identified in the first indication via one or more indices that correspond to a first table that includes different predefined feature values for different feature characteristics of the one or more objects; where the first table includes a first index value that corresponds to a first set of feature characteristics and a second index value that corresponds to a second set of feature characteristics, and where the first set of feature characteristics and the second set of feature characteristics include at least one common feature characteristic.

Some implementations of the methods and apparatuses described herein may further include: where the one or more feature characteristics of the one or more objects are further identified in the first indication via one or more indices that correspond to a second table that includes predefined features values for different feature characteristics of the one or more objects; transmitting reference signal information for the one or more reference signals, the reference signal information including at least one of: one or more of a waveform type or a set of waveform-defining parameters for a waveform used to transmit the one or more reference signals; a set of resources over which the one or more reference signals are transmitted according to the waveform; one or more of a transmit beam pattern or a radio pattern over which the one or more reference signals are transmitted; a transmit power used to transmit the one or more reference signals; a sequence generation and physical-resource-mapping type used to generate the one or more reference signals; or a location of a device that transmits the one or more reference signals.

Some implementations of the methods and apparatuses described herein may further include: transmitting sensing configuration information for the radio sensing, the sensing configuration information including at least one of: an indication of one or more receive spatial filters to be used for a reception of the one or more reference signals; an indication of one or more known attributes of the one or more feature characteristics of the one or more objects; or one or more types of output to be provided based on the radio sensing; further including: transmitting the first indication via a first signaling type; and transmitting the sensing configuration information via a second, different signaling type; where the one or more types of output to be provided based on the radio sensing includes at least one of: one or more of quantized received reference signals or compressed reference signals; CSI measurements for the reference signals; inference of a presence of the one or more objects; estimated location of the one or more objects; estimated velocity of the one or more objects; estimated RCS of the one or more objects; estimation of one or more of type, shape, composite, or posture of the one or more objects; an indication of a sensing quality of service of the radio sensing; or combinations thereof.

Some implementations of the methods and apparatuses described herein may further include: where the one or more types of output to be provided based on the radio sensing are indicated via one or more indices that correspond to a table that includes different types of output to be provided based on radio sensing; where the one or more types of output to be provided based on the radio sensing is indicated via one or more indices that correspond to a table that includes different output values for different types of output to be provided based on radio sensing; where the CSI measurements include at least one of: a CSI domain; one or more of a segment or a margin within the CSI domain; or an operation to be performed over the CSI measurements within the indicated one or more of the segment or margin; where the CSI domain includes at least one of: delay domain; angular-azimuth domain; one or more of angular-elevation or zenith domain; one or more of channel or CSI periodogram; or doppler domain.

Some implementations of the methods and apparatuses described herein may further include: where the one or more feature characteristics of the one or more objects are identified in the first indication via one or more indices that correspond to a first table that includes different predefined feature values for different feature characteristics of the one or more objects, and where the second indication identifies output of the radio sensing via one or more indices the correspond to the first table; where the CSI measurements include, for the one or more feature characteristics, at least one of: CSI measurements on an intersection of the one or more feature characteristics; CSI measurements on a union of the one or more feature characteristics; or a combination thereof; transmitting the first indication via one or more of higher layer signaling or defined physical channels of a communication network; transmitting a third indication including at least one of: a set of time, frequency, and beam resources for transmission of the second indication; at least one criterion for the transmission of the second indication; or a type of information included in the second indication.

Some implementations of the methods and apparatuses described herein may further include receiving radio sensing measurements of an environment; receiving processing configuration information for a processing configuration used to generate the radio sensing measurements; extracting, from the radio sensing measurements and based at least in part on the processing configuration information, sensing information for the environment; and transmitting a report based on the extracted sensing information for the environment.

Some implementations of the methods and apparatuses described herein may further include: receiving the radio sensing measurements from multiple devices and combining at least some of the radio sensing measurements from the multiple devices to extract the sensing information for the environment; receiving one or more feature characteristics of one or more objects, and extracting the sensing information further based at least in part on the one or more feature characteristics of the one or more objects; receiving the radio sensing measurements of the environment from a first device and receiving the processing configuration information from a second, different device; receiving the radio sensing measurements of the environment and the processing configuration information from a same device; where the processing configuration information includes at least one of: preprocessing applied to the radio sensing measurements; domain translation applied to the radio sensing measurements; windowing applied to the radio sensing measurements; space reduction applied to the radio sensing measurements; or postprocessing applied to the radio sensing measurements; where the sensing information includes attributes of one or more objects detected in the environment.

### BRIEF DESCRIPTION OF THE DRAWINGS

FIG. 1 illustrates an example of a wireless communications system that supports configuration for radio sensing in accordance with aspects of the present disclosure.

FIG. 2 illustrates an example scenario for radio sensing that supports configuration for radio sensing in accordance with aspects of the present disclosure.

FIG. 3 illustrates example scenarios for radio sensing that support configuration for radio sensing in accordance with aspects of the present disclosure.

FIG. 4 illustrates example scenarios for radio sensing that support configuration for radio sensing in accordance with aspects of the present disclosure.

FIG. 5 illustrates an example table for radio sensing that supports configuration for radio sensing in accordance with aspects of the present disclosure.

FIG. 6 illustrates a system for radio sensing that supports configuration for radio sensing in accordance with aspects of the present disclosure.

FIG. 7 illustrate an example block diagram of devices that support configuration for radio sensing in accordance with aspects of the present disclosure.

FIGS. 8 through 12 illustrate flowcharts of methods that support configuration for radio sensing in accordance with aspects of the present disclosure.

### DETAILED DESCRIPTION

In some wireless communications system designs, radio sensing in wireless cellular wireless networks is envisioned both as a mechanism to improve network performance as well as to serve vertical use-cases. Radio sensing, for example, uses radio signals and/or devices to attempt to detect attributes of an ambient environment. As part of radio sensing, radio signals that are propagated and/or reflected are to be received and processed to determine environmental attributes such as objects present in an environment. Some current designs for radio sensing, however, do not provide for utilization of radio sensing intelligence for processing radio sensing data and thus may experience inaccuracies and/or processing latency when attempting to interpret radio sensing data.

Accordingly, the present disclosure relates to methods, apparatuses, and systems that support configuration for radio sensing. For instance, implementations provide configuration of radio sensing nodes including information elements defining a priori known features of objects and/or scenarios of interest for radio sensing. Codebook-based definitions of prior knowledge of object features, for example, are provided. Utilization of the same codebook and/or other codebook(s) for the indication of the prior knowledge on the object features and the sensing measurement output values are also provided.

Further, CSI-based procedures are described including CSI domain translation and CSI domain reduction. For instance, computation and/or signal processing is described to generate radio sensing results including to extract relevant portions of CSI information according to radio sensing scenarios. Implementations also include the introduction of conditioned RSRP, RSRQ, and RSSI measurements within a configured region of a defined CSI domain as part of radio sensing.

Accordingly, the implementations described in this disclosure provide a number of improvements and advantages, including:
Improving radio sensing accuracy such as enabled by focusing on a measured signal space, and hence, reducing the inclusion of noise and interference;
Reducing reporting overhead such as enabled by the collection of focused information and reduction of the unnecessary information from sensing reports;
Reduction of the processing complexity, and hence, energy and computation power consumption, such as enabled by reducing processing of irrelevant information;
Enabling the distribution of the sensing task among multiple sensing Rx measurements, such as to distribute computation, sensing, measurement, and/or processing burden; and
Improving information privacy of radio sensing operations such as by limiting information exposed towards the network and/or unauthorized third-party nodes and/or eavesdroppers.

Aspects of the present disclosure are described in the context of a wireless communications system. Aspects of the present disclosure are further illustrated and described with reference to device diagrams and flowcharts.

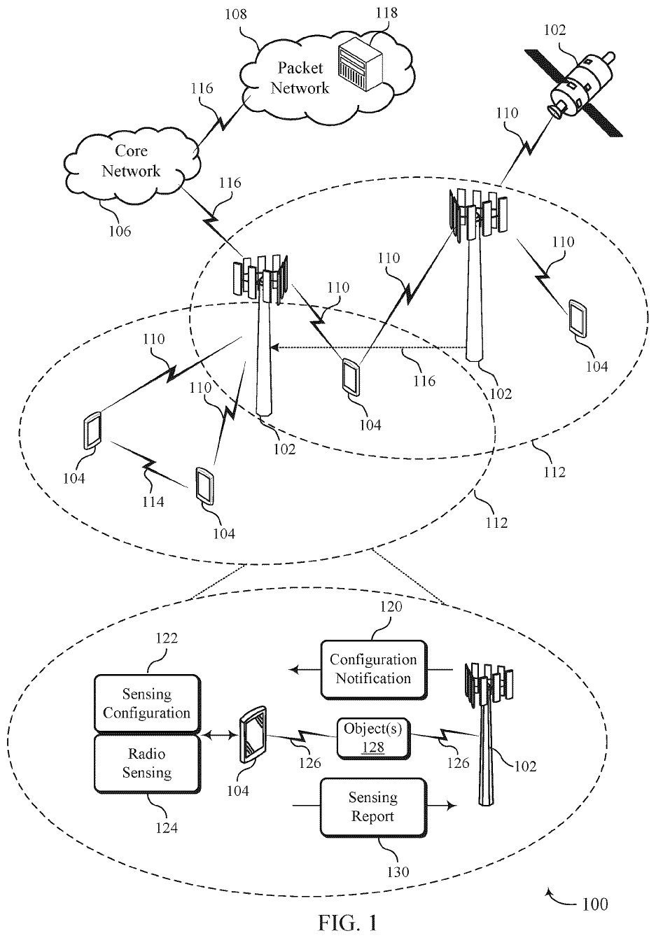

FIG. 1 illustrates an example of a wireless communications system 100 that supports configuration for radio sensing in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for configuration for radio sensing, a network entity 102 and a UE 104 can cooperate to enable radio sensing according to the described implementations. In this particular example the network entity 102 represents a sensing transmit node (“sensing Tx node”) and the UE 104 represents a sensing receiver node (“sensing Rx node”). This is not to be construed as limiting, however, and a variety of different node types and node implementations may be utilized as part of the disclosed implementations, such as further described below.

Further to the described example, a network entity 102 generates a configuration notification 120 and transmits the configuration notification 120 to a UE 104. The configuration notification 120, for instance, includes various radio sensing-related configuration information such as known attributes of objects and/or scenarios of interest, processing configuration information for use in processing radio sensing measurements, reporting configuration for reporting radio sensing measurements, and so forth. In at least one implementation the configuration notification 120 references configuration information using indices to a codebook that includes fields that describe different objects and/or scenarios of interest. Detailed examples of different instances and/or types of radio sensing-related information that can be included in the configuration notification 120 are discussed throughout this disclosure.

The UE 104 receives the configuration notification 120 and implements (e.g., executes) sensing configuration 122 to configure different radio sensing-related logic and behaviors of the UE 104 based at least in part on the configuration notification 120. The sensing configuration 122, for instance, configures sensing, processing, and/or reporting logic and/or behaviors of the UE 104 and based at least in part on the configuration notification 120. Based on the sensing configuration 122, the UE 104 executes radio sensing 124. The radio sensing 124, for example, is based on reference signals 126 that are transmitted by the network entity 102 and received by the UE 104. The radio sensing 124 can be utilized to detect objects 128 (e.g., objects of interest) that affect propagation of the reference signals 126, such as via signal interference, signal reflection, etc., caused by the objects 128. As further detailed below, the radio sensing 124 can utilize known object information included as part of the sensing configuration 122 to identify and/or confirm identity of the objects 128.

Based at least in part on the radio sensing 124 and/or processing of sensing measurements obtained by the radio sensing 124, the UE 104 generates a sensing report 130 and transmits the sensing report 130 to the network entity 102. The sensing report 130 can include various types of information such as sensing measurements generated by the radio sensing 124, processed sensing measurements, sensing configuration 122 information used by the UE 104 to generate and/or process sensing measurements, and so forth. In at least one implementation the sensing report 130 is generated and/or transmitted according to reporting configuration information included as part of the sensing configuration 122. The network entity 102, for instance, specifies reporting configuration information in the configuration notification 120 to be used by the UE 104 to generate the sensing report 130.

In some wireless communications system designs, radio sensing in wireless cellular wireless networks is envisioned both as a mechanism to improve network performance, as well as to serve vertical use-cases. In particular, radio sensing can obtain environment information by the means of:
transmission of a sensing excitation signal, e.g., a sensing reference signal (RS), from a network or UE entity, e.g., sensing Tx node;
reception of the reflections/echoes of the transmitted sensing excitation signal from an environment by a network and/or a UE entity, e.g., sensing Rx node; and
processing of the received reflections and inferring relevant information from the environment.

As indicated above, the propagated/reflected radio signals can be received and processed to extract environmental features and information of interest. Accordingly, it can be desirable to tailor signal reception, measurement, processing, and reporting processes to the nature of specified radio sensing tasks and information and the specified quality of service. An example list of the potential use-cases for such task-specific radio sensing measurements and reporting include, but not limited to:
Measurement of the radio propagations for detection of an object of interest, where the object, if present, is located in a known three dimensional (3d), or two dimensional (2d), and/or 1 dimensional (1d) area. Examples of different objects of interest include a pedestrian crossing a known road section, a train passing by the known route, a vehicle (e.g., driven by a human driver and/or autonomous vehicle) moving down a known road section, etc.
Measurement of the radio propagations for detection of an object of interest, such as where the object, if present, follows a specific velocity pattern. For instance, for an object of interest, the direction of travel is known and/or the absolute velocity is within an a priori known range and leads to a CSI component within an a priori known region in the doppler domain, e.g., a pedestrian with no more than 30 km/hour speed, a natural obstacle with zero speed, etc.

Example features for defining UE capabilities for sensing, where the UE acts as a sensing Tx for a sensing task associated with a sensing RS can be defined via a set of supported sensing RS patterns, including (but not limited to):
A supported time-domain resource pattern for sensing RS, e.g., a maximum supported length of the sensing RS in time domain, maximum number of symbols or symbol density for sensing RS transmission, maximum supported power/energy for sensing RS transmission, etc.
A supported frequency-domain resource pattern for sensing RS, e.g., a maximum supported bandwidth of the sensing RS in a frequency domain, maximum number of resource elements (REs) or RE density for sensing RS transmission, maximum supported power/energy for sensing RS transmission within a symbol, slot, and/or a radio frame, etc.
A supported joint time-frequency domain resource pattern for sensing RS, e.g., a maximum supported number of total REs per radio frame for sensing RS transmission, maximum supported power and/or energy for sensing RS transmission within a symbol, slot, and/or a radio frame, the supported frequency hopping patterns, etc.
Supported spatial filters, beams, and/or maximum supported number of simultaneously used spatial beams for sensing RS transmission.
Supported guard interval or cyclic prefix (CP) overhead for sensing symbols within sensing RS transmission.
Supported computation and/or determination for choosing the sensing RS resource pattern among a set of possible patterns for sensing RS transmission.
Supported computation and/or determination methods for choosing the sensing RS sequence among a set of possible sequences for sensing RS transmission.
Supported sequence generation strategies and/or the supported sets of sequence-generation defining parameters for sensing RS transmission.
Supported sequence-to-resources mapping-defining parameter set for sensing RS pattern generation for transmission.

Example features for defining UE capabilities for sensing, where the UE acts as a sensing Rx for a sensing task associated with a sensing RS can be defined via a set of supported sensing RS patterns, including (but not limited to):
Supported time-domain resource pattern for sensing RS reception, e.g., a maximum supported length of the sensing RS in time domain, maximum number of symbols or symbol density for sensing RS reception, etc.
A supported frequency-domain resource pattern for sensing RS reception, e.g., a maximum supported bandwidth of the sensing RS in frequency domain, maximum number of REs or RE density for sensing RS reception, etc.
A supported joint time-frequency domain resource pattern for sensing RS reception, e.g., the maximum number of total REs per radio frame for sensing RS reception, the supported frequency hopping patterns for sensing RS reception, etc.
Supported spatial filters, beams, and/or maximum number of simultaneously used spatial beams for sensing RS reception.
Supported guard interval and/or CP overhead for sensing symbols within sensing RS reception.
Supported detection and/or determination for an unknown (e.g., partially unknown) received sensing RS resource pattern among a set of possible patterns for sensing RS reception.
Supported detection and/or determination for an unknown (e.g., partially unknown) received sensing RS sequence among a set of possible sequences.
Supported sequence generation strategies for sensing RS transmission.
Supported sequence-to-resources mapping-defining parameter set for sensing RS reception.

Example features for defining UE capabilities for sensing, where the UE acts jointly as a sensing Rx and sensing Tx (e.g., in a full-duplex with simultaneous transmission and reception) for a sensing task associated with a sensing RS can be defined via a set of the supported sensing RS patterns, including (but not limited to):
Supported time-domain resource pattern for sensing RS joint transmission and reception.
Supported frequency-domain resource pattern for sensing RS joint transmission and reception.
Supported joint time/frequency-domain resource pattern including supported frequency hopping patterns for sensing RS joint transmission and reception.
Supported transmit and receive beam combinations for sensing RS joint transmission and reception.
Supported transmit power, e.g., average transmit power during sensing, maximum average transmit power during sensing in any of the slots, maximum transmit power during any transmit symbol, total sensing RS energy, for sensing RS joint transmission and reception.
Features for supported transmit power for sensing which are defined specific to a transmit beam or Tx/Rx beam combination supported for joint sensing RS transmission and reception.
Features defining allowed combinations of the supported set of sensing RS for transmission and the supported set of sensing RS for reception.

Example features for defining UE capabilities for sensing RS multiplexing can include (but are not limited to):
Number of sensing RS that can be multiplexed within a same radio frame and/or exist at the same time, e.g., exist when other ones are started and before the other ones are ended.
Type of data and/or control channels or other RSs that can coexist with a sensing RS, e.g., exist after the channel and/or RS starts and before the said channel and/or RS ends.
Support of discrete Fourier transform (DFT) spreading on the sensing RS and/or a multiplexed sensing RS.
For all the above, a supported type of multiplexing.

Example features for defining UE capabilities for sensing measurements, where the UE operates as sensing Rx can be defined via a set of supported measurement types, including (but not limited to):
Supported methods and/or computational models for sensing measurement, e.g., time-domain processing for time-of-flight estimation, CP-OFDM-based doppler and/or range estimation, available computational and/or artificial intelligence (AI) models for sensing measurements.
Support for distance and/or range estimation, supported dynamic range of the object distance for estimation, supported distance estimation resolution.
Support for object speed estimation, supported dynamic range of the object speed for estimation, supported speed estimation resolution.
Support for angular estimation (e.g., direction of arrival (DoA) estimation), supported dynamic range of DoA for estimation, supported DoA estimation resolution.
Maximum number of simultaneously supported objects for sensing measurements.
Support for measurement features defined as a combination of any of the above features, e.g., support of DoA estimation for the objects with a specific distance dynamic range and a specific distance resolution.

Example features for defining UE capabilities for sensing measurements reporting, where the UE operates as sensing Rx can be defined via a set of supported measurement reporting types, including (but not limited to):
Types of the supported message and/or reporting, e.g., compression of the measurements, estimated parameters, event-based reporting with a defined criterion, etc.
Duration that a measurement message can be stored by the UE before transmission and/or reporting.
Supported reporting criterion, e.g., comparison of an estimated distance with a threshold, and/or computational models for checking a reporting criteria.
Supported compression types for a reporting message.

For particular radio sensing tasks, information elements that specify sensing QoS and/or sensing information type include (but are not limited to):
Sensing information type: in some implementations, a type of information to be obtained via a sensing procedure can be included in a request message. This includes, e.g., indication of a request for object and/or blockage detection, material and/or composite estimation, tracking and/or ranging of an object of interest, estimating the speed of an object of interest, etc. In some implementations, requested information can be defined explicitly to facilitate scheduling and/or a proper response determination by the network.
QoS for sensing information: In some implementations, QoS parameters for the requested sensing information is included in a request message, e.g., by a UE. Examples of this sensing QoS information include (but are not limited to):
   Latency: the tolerable latency requirement for the accomplishment of the requested sensing operation. The measurable time duration may be defined as the time-difference from the transmission of the request or reception of the request by the network to one or more of: the reception of the response from the network, reception of a sensing RS transmitted in response to the UE request, accomplishment of the sensing procedure, or reception and/or recovery of the intended sensing information by the UE, etc.
   Reliability/Accuracy: information on the accuracy of the obtained sensing information can be defined, such as via one or more of: tolerable probability of false alarm for detection within an object and/or area of interest, specified probability of detection for detection within an object and/or area of interest, tolerable error measure for parameter estimation, e.g., estimation of speed or distance of an object of interest.
   Request importance: In some implementations, an indication of the importance (e.g., significance) of the requested information is also included in the request message, such as a different (e.g., separate) information element relative to other QoS descriptions for sensing. The indication of importance, for example, indicates a priority of the network for responding positively to the requested service. A UE, for instance, may include in the request message a priority identifier and/or class for different types of requests.
   Security/privacy: In some implementations, a sensing operation is requested to accompany measures for protecting the sensing information, such as information pertaining to signal propagation and/or reflection from an object and/or area of interest that may be used by an unauthorized third-party. A type of the security measure may be included in the request message, such as for object of interest sensing information protection, area of interest sensing information protection, requesting-UE identity protection together with a specified level of security, e.g., as an integer number defining a specified security level.

Accordingly, solutions are provided in this disclosure to provide intelligent radio sensing including optimizing radio sensing measurements and signal processing, and reporting for radio sensing operations based on known attributes of radio sensing environments.

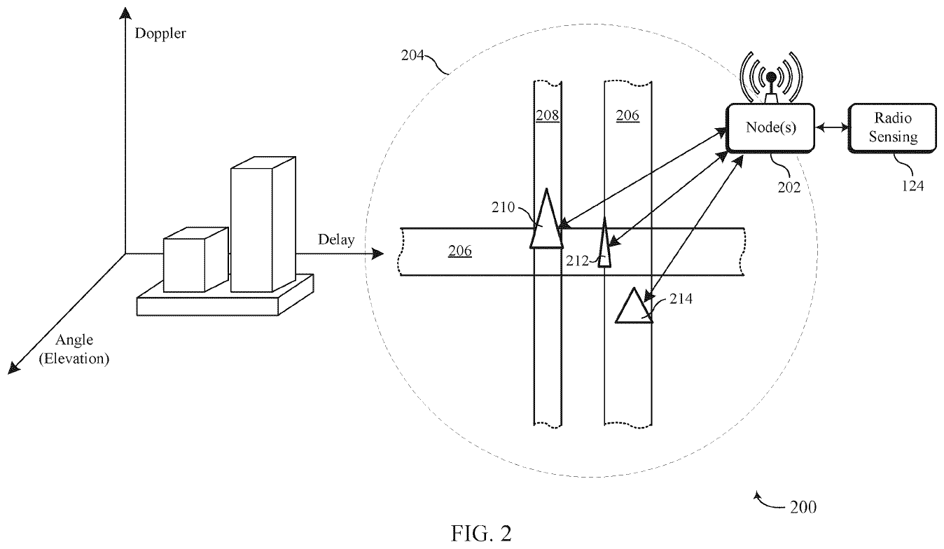

FIG. 2 illustrates an example scenario 200 for radio sensing that supports configuration for radio sensing in accordance with aspects of the present disclosure. In the scenario 200 one or more nodes 202 perform radio sensing 124 of an environment 204. Further, the environment 204 includes various features such as roads 206 and a railway 208. The environment 204 also includes objects 128 including a train 210 on the railway 208, a pedestrian 212 adjacent a road 206, and a car 214 on a road 206. The objects 128, for instance, are detected by the radio sensing 124 based on different feature characteristics of the objects 128, such as object velocity, object size (e.g., area), object location within the environment 204, etc. In implementations, the location and speed range of the objects 128 are a priori known and projected into components of CSI within a known margin for delay, angle (e.g., potential area), and doppler (potential velocity range). The a priori-known characteristics of the objects 128 and the environment 204 can be utilized in implementation of radio sensing-related signal processing and measurements.

The one or more nodes 202 can be implemented via various types and/or combinations of nodes, such as UEs 104, network entities 102, and combinations thereof. Accordingly, as discussed herein, a node such as a sensing Tx node and a sensing Rx node can refer to a network entity 102, a UE 104, and combinations thereof. The implementations described in this disclosure, for example, are applicable to a wide variety of different sensing scenarios. For instance, the described implementations are applicable in radio sensing scenarios where the network configures the participating sensing entities (e.g., network and UE nodes acting as sensing Tx nodes, and network and UE nodes acting as sensing Rx nodes) as well as the configuration of sensing RS and corresponding measurements and reporting procedures from the nodes. The functional allocation between the network and the UE nodes for a specific sensing task, for instance, may take various forms, such as based on the availability of sensing-capable devices and parameters pertaining to specific sensing operations.

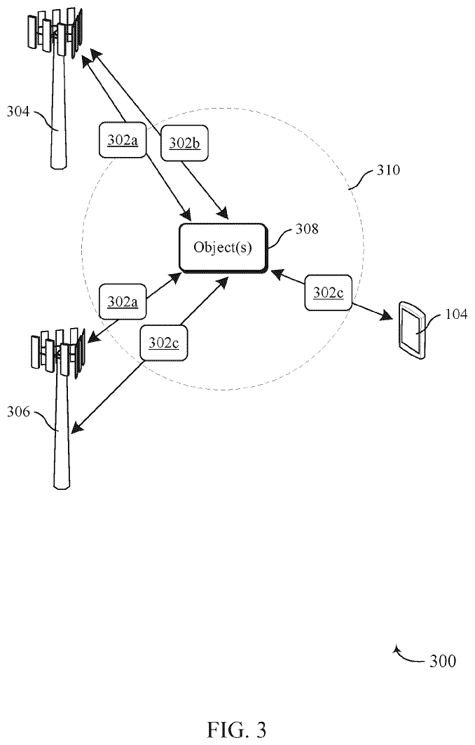

FIG. 3 illustrates example scenarios 300 for radio sensing that supports configuration for radio sensing in accordance with aspects of the present disclosure. The scenarios 300 include:

Scenario 302a with a sensing Tx as a network node 304 and sensing Rx as a separate network node 306, which represent different instances of network entities 102: In the scenario 302a, the sensing RS (and/or another RS used for sensing or data and/or control channels known to the network TRP nodes) is transmitted and received by network entities 102. The involvement of UE nodes can be limited such as to aspects of interference management. The network may not utilize UEs for sensing assistance in the scenario 302a.

Scenario 302b with a sensing Tx as the network node 304 and sensing Rx as the same network node 304: In the scenario 302b, the sensing RS (and/or another RS used for sensing or the data and/or control channels known to the network TRP nodes) is transmitted and received by the same network entity 102. The involvement of UE nodes can be limited such as to aspects of interference management. The network may not utilize UEs for sensing assistance in the scenario 302b.

Scenario 302c with a sensing Tx as the network node 306 and a sensing Rx as a UE 104: In the scenario 302c, the sensing RS or other RS used for sensing is transmitted by a network entity 102 and received by one or multiple UEs 104. A network, for instance, configures the UE(s) 104 to act as a sensing Rx node, such as according to the UE nodes capabilities for sensing and/or a specified sensing task.

As part of the scenarios 302a-302c, the radio sensing is implementing to detect feature characteristics of objects 308 present in an environment 310.

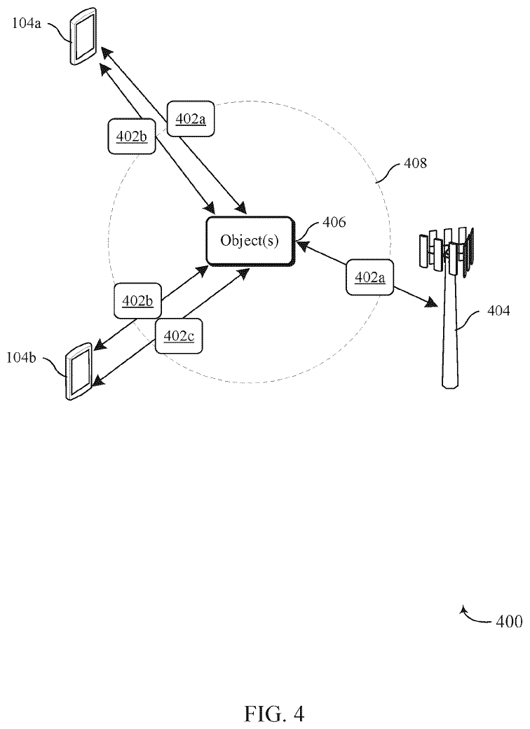

FIG. 4 illustrates example scenarios 400 for radio sensing that supports configuration for radio sensing in accordance with aspects of the present disclosure. The scenarios 300, 400, for example, represent additional and/or alternative implementations. The scenarios 400 include:

Scenario 402a with a sensing Tx as a UE 104a and sensing Rx as a network node 404: In the scenario 402a, the sensing RS or other RS used for sensing (and/or a data and/or control channel transmitted by the UE 104a) is received by one or multiple network entities 102 (e.g., the network node 404) and transmitted by the UE 104a. A network, for instance, configures the UE 104a to act as a sensing Tx node, such as according to the UE 104a capabilities for sensing and/or a specified sensing task.

Scenario 402b with a sensing Tx as the UE 104a and a sensing Rx as a separate UE 104b: In the scenario 402b, the sensing RS or other RS used for sensing is received by one or multiple UEs 104b and transmitted by the UE 104a. In this scenario, the network and/or a UE 104 may decide on configuration of the sensing scenario. In at least one example, a network configures the UEs 104 to act as a sensing Tx and/or sensing Rx nodes, such as according to the UE 104 capabilities for sensing and/or a specified sensing task.

Scenario 402c with a sensing Tx as the UE 104b and sensing Rx as the same UE 104b: In the scenario 402c, the sensing RS (and/or another RS used for sensing and/or the data and/or control channels known to the UE) is transmitted by the UE 104b and received by the same UE 104b. In at least one implementation, the UE 104b and/or a network configures the sensing scenario, such as according to the UE 104 capabilities for sensing and/or a specified sensing task.

As part of the scenarios 402a-402c, the radio sensing is implementing to detect feature characteristics of objects 406 present in an environment 408. Further, the different scenarios 302, 402 are presented for purpose of example only, and it is to be appreciated that implementations for configuration for radio sensing can be employed in a variety of different scenarios including scenarios not expressly described herein.

In at least some implementations, sensing Rx configurations are provided that include known (e.g., a priori known) feature characteristics of objects that can be sensed via radio sensing. For instance, a radio sensing controller entity (e.g., a network entity 102) configures a sensing Rx node with one or multiple of:
(1) A first configuration regarding the transmission of a sensing RS signal by a sensing Tx node, to be received and processed by the said sensing Rx node;
(2) A second configuration for an expected receiver signal processing and/or measurements of the received sensing RS as part of a radio sensing operation, based on, among other considerations, the known characteristics of an object of interest and/or a respective radio sensing scenario; and
(3) A third configuration for the transmission of a report from the performed sensing processing, such as according to the first and second configurations.

The sensing Rx node can then perform the reception of the sensing RS and perform respective radio sensing measurement and/or processing according to the received first and second configurations, and subsequently may generate and transmit a report according to the received third configuration.

In at least some implementations, the radio sensing controller entity may be implemented as and/or operate as part of a third-party application on a UE device, a RAN node (e.g., a gNB, a smart repeater, a IAB node, a UE/gNB-roadside unit (RSU), etc.), as part of a core network entity, e.g., a radio sensing management function, etc. Further to at least some implementations, a set of sensing Rx nodes associated with a radio sensing scenario may include UE devices, network entities (e.g., gNB nodes), UE/gNB-RSU nodes, smart repeaters, IAB nodes, smart repeater node, and/or combinations thereof.

The first configuration such as introduced above for the transmitted sensing RS signal by a sensing Tx node to be received by the sensing Rx node may include at least one or multiple of:
a) A waveform type or waveform-defining parameters for the sensing RS signal, e.g., the waveform type in case the waveform is different from that of the used waveform for other data/control transmission/receptions by the same nodes, subcarrier spacing (SCS) for the sensing RS signal in case of OFDM-based waveforms or other multi-carrier waveform types, the length and type of redundancy, e.g., CP-length in case of CP-OFDM, or redundancy type and length in case of unique word (UW)-OFDM;
b) The location of the sensing Tx (the sensing RS transmitting entity) according to a global or local/relative or known coordinate system by the sensing Rx, or a relative location of the sensing Tx with respect to the object/area of interest to radio sensing;
c) One or multiple Tx antenna port or transmission beams or transmission radiation pattern or transmission radiation characteristics (e.g., panning angle, beam angle in azimuth, beam angle in elevation/zenith, beam width) for the transmission of the sensing RS;
d) Sensing RS resources according to the used waveform for sensing RS transmission, e.g., CP-OFDM time/frequency resources over which the sensing RS is transmitted;
e) Tx power for the transmission of the sensing RS;
f) Sequence generation and physical-resource-mapping type based on which sensing RS signal is generated.

The second configuration such as introduced above for the receiver signal processing and/or measurements of the received sensing RS may include one or more of:
a) Indication of one or more Rx spatial filters to be used by the sensing Rx for the reception of the sensing RS signal;
b) Indication of one or multiple features of an object and/or scenario of interest for sensing according to which sensing measurements and/or signal processing is to be implemented;
c) One or multiple types of processing and/or computation results to be generated from the received sensing RS, the received configurations.

Further, the second configuration such as introduced above for the receiver signal processing and/or measurements of the received sensing RS may be determined (e.g., by a radio sensing controller) based on one or more of:
a) A priori known characteristics of an object or objects of interest, such as related to a specified radio sensing operation;
b) A radio sensing-related capability of a sensing Rx node, e.g., including but not limited to:
   i. Stationarity (e.g., position stability) of the sensing Rx for a specified sensing duration;
   ii. One or more of time, frequency, angular, or location synchronization level of the sensing Rx with the sensing Tx node(s);
   iii. Observability region of the sensing Rx with respect to the object and/or area of interest.
c) Radio sensing-related capability of other participating sensing Rx nodes in the sensing scenario;
d) Availability of one or more of time, frequency, energy, storage resources, or processing resources for the radio sensing operation among the available radio sensing nodes;
e) Specified quality-of-service for a specified radio sensing task.

In at least some implementations, a priori known features of an object and/or scenario of interest for sensing according to which sensing measurements and/or signal processing is to be implemented may include one or more of:
a) Expected object presence probability;
b) A probability mass function of the number of existing objects within the related sensing area of interest;
c) A location, a location range, set, and/or potential area of an object of interest (if present) according to a coordinate system such as a global, local, relative, and/or known coordinate system to a sensing Rx node;
d) A probability mass function of an object position conditioned on the object being present, e.g., 0.2 probability of object occurrence over a cube identified by (5,5,5)<(x,y,z)<(15,15,15) in 3D; 0.2 probability of occurrence within a 2D rectangular area (5,5)<(x,y)<(15,15); 0.2 probability of occurrence over a 1D area representation 5<x<15; and/or 0.2 probability of occurrence over an angular region representation (e.g., azimuth and/or elevation/zenith angle range) according to a coordinate system such as a global, local, relative, and/or known coordinate system to a sensing Rx node;
e) A velocity and/or a velocity set and/or range, such as including an absolute velocity range and/or possible directions of movement, e.g., direction or angular range of movement with respect to a coordinate system such as a global, local, relative, and/or known coordinate system of an object of interest conditioned on the object being present;
f) A probability mass function of the object velocity (absolute velocity, velocity direction, and/or or directional velocity, e.g., which can be combined) over known velocity segments, e.g., 0.2 probability of occurrence over 10-20 kilometers per hour (kmh) along the north direction with +/−10 degree deviation, 0.3 probability of occurrence over 10-20 kmh, 0.4 probability of occurrence with a movement along the north direction with +/−10 degree deviation, etc.;
g) A probability mass function of the object Doppler characteristics. e.g., Doppler range and/or spread;
h) Expected object RCS pattern and/or parameters related to a resulting RCS pattern, e.g., object size, object composite, object material, and object figure, or a probability mass function on different combinations thereof, e.g., probability mass function for different RCS pattern and/or value ranges on different object sizes or shapes;
i) One or multiple potential object types (e.g., a person, a vehicle, a cat, a dog, a building, a wall, etc.) and/or a probability mass function thereof;
j) A semantic representation of an object as a feasible state that for an object and/or a mass probability density function thereof, e.g., a possible human or animal body posture: e.g., standing, sleeping, bending, different standing postures, different hand gestures, different heart and/or breathing states, etc.;
k) Indication to a prior sensing Rx processing and/or a known object type by the sensing Rx node where the object of interest, if present, may share properties with the known or previously analyzed object by the sensing Rx node;
l) Features obtained from the combination of instances of the above features, e.g., joint probability mass function over multiple domains, e.g., power-angle-delay-doppler segments of the measured CSI.

Instances of the probability measures discussed herein may be presented as unconditional values and/or conditional probability measures, such as conditioned on an object being present.

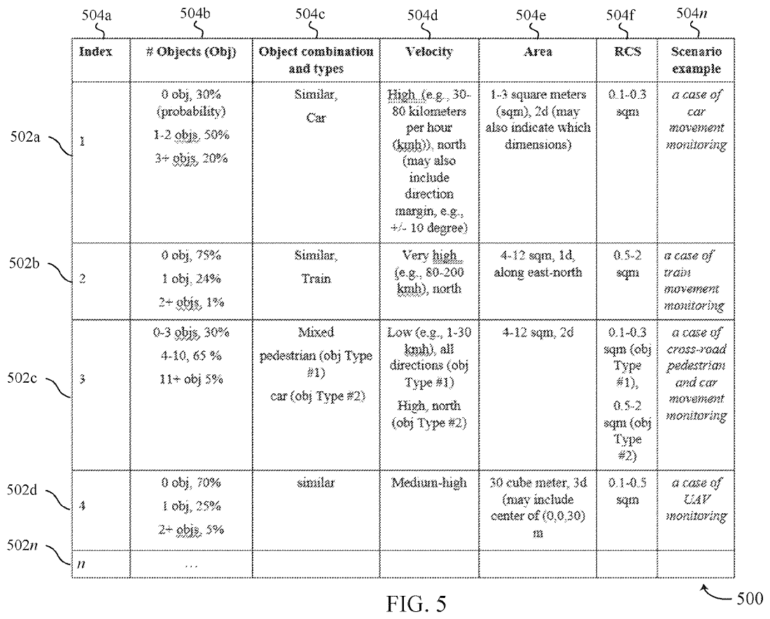

FIG. 5 illustrates an example table 500 for radio sensing that supports configuration for radio sensing in accordance with aspects of the present disclosure. The table 500, for example, can be implemented as part of a codebook for radio sensing. For instance, the features of an object of interest for sensing and/or the scenario of interest (potentially including multiple objects), and/or subsets thereof can be indicated via one or multiple indices from a codebook, where the codebook includes different predefined feature sets of feature characteristics. The table 500 includes different entries 502a, 502b, 502c, 502d, and 502n that each correspond to different index values from an index field 504a. Further, different fields 504b, 504c, 504d, 504e, 504f, and 504n define different attributes of objects and/or scenarios of interest.

In at least some implementations, each one or multiple of the mentioned fields may be defined via a separate or combined codebook, including the definition of value ranges, e.g., for object position, area, velocity, direction, RCS, and/or combinations thereof. Further, indices from one codebook can be used to define one set of object features, and other object features can be indicated via indices from another codebook. Object features may also be indicated explicitly such as via parameter values defining the features, e.g., object direction and/or orientation, if an object is detected, a maximum number of objects that may exist at the same time within the detection area, etc.

In at least some implementations, multiple indices indicated from a codebook and/or table can indicate a range of valid indices between the two indicated indices. Further, multiple indices indicated from a codebook and/or table can indicate that multiple corresponding conditions (e.g., when a condition corresponds to object features defined by the indicated index within the table and/or codebook) can apply concurrently. In at least some implementations, an index from a table and/or codebook indicates that the conditions corresponding to the features defined via the corresponding index may not apply. Further, a combination of any of the above implementations for the indication of multiple indices may be utilized to define the features of interest. In at least some implementations, the a priori known features are indicated with two indices, e.g., via a velocity value from a codebook defining absolute velocity, where the two indices represent the range of velocities. For instance, a measured velocity of an object may be indicated via a single index from the same codebook, or via two different indices from the same codebook such as for defining a smaller range of the absolute velocity values after the measurements. In at least some implementations, an indicated index from a codebook may be associated to indicate multiple indices from a codebook and/or table.

According to one or more implementations, one or a combination of the information types described above for a priori known features of the object/scenario of interest for sensing can be utilized for the presentation of sensing processing and/or computation outcome. For instance, the a priori known features of an object and/or scenario of interest can be adjusted and/or updated with the assistance of the performed measurements at the sensing Rx, thus representing a posterior information about the object of interest. In at least one implementations, the posterior probability mass function of the number of present objects is calculated based on the a priori known probability mass function of the number of the present objects as well as the performed measurements by the sensing Rx node, and is presented via an index from a same codebook and/or table defined for presenting the probability mass function of the number of present objects. Further, the obtained posterior information can be presented via a different codebook, e.g., by presenting the posterior probability mass function of the number of present objects with a codebook defining more precisely a number and/or type of the present objects. In at least some implementations, a sensing processing outcome is of a different information type than the a priori known information on an object of interest, e.g., when the object is located in an a priori known delay or angular range, and the sensing Rx processing can estimate the object velocity, utilizing the prior information.

According to one or more implementations, a type of the processing and/or computation outcome may further include one or multiple of:
a) Detection of an object of interest given the indicated features of the sensing scenario and the object of interest, the detection may include an indication of a probability of object being present or absent. For instance, an object is detected to be present with a probability in the range of 90-95 percent, or the object is detected as not present with the probability of 90 percent or more;
b) A number of existing objects within the object set of interest to be detected and/or monitored;
c) A probability mass function for the number of existing objects, e.g., 0.1 probability for no object, 0.8 for 1 object, and 0.1 probability for two objects of interest or above.
d) A measured CSI associated from the sensing RS reception and/or a quantized version of the measured CSI utilizing the indicated features of the object of interest, e.g., CSI measured within a relevant delay, doppler, and/or angular margin, and/or compressed according to the significance inferred from the features of the object of interest;
e) An estimation of one or combination of sensing-relevant parameters associated with a present object of interest (e.g., as a priori detected via the above step a)), where the sensing-related parameters may include one or multiple of:
   i. Object (3-d, 2-d, or 1-d) position, with respect to a known and/or global coordinate system,
   ii. Time of flight (ToF) of the reflected path including the object of interest;
   iii. Object velocity direction, velocity intensity, or a combination thereof, e.g., velocity towards a specific direction of interest, size of the object of interest, etc.;
   iv. A perceived doppler shift of the reflected path including the object of interest;
   v. A composite of the object of interest, e.g., weather pollution estimation, object material estimation, etc.;
   vi. A combination of one or more of the above parameters as a parameter array.
f) Quantized estimates of the parameters as defined in the above steps, or the quantized version of the combined parameters as an array quantization, where quantization steps can include one or more of:
   i. Absolute velocity region, e.g., 10<vel.<30 kmH;
   ii. 10<vel.<30 kmH and in north-east direction;
   iii. Position region of (9,9,10)<(x,y,z)<(10,10,10)
   iv. Position region of (9,9,10)<(x,y,z)<(10,10,10) and 10<vel.<30 kmH and in north-east direction;
   v. 0-1 cube meters or 1-5 cube meters large for the size of the object of interest.
g) A classification of an object into different types and/or categories, e.g., a standing human, walking pedestrian, a moving car, outgoing train, a tree, wall, animal (e.g., cat/dog), etc. In at least some implementations, the detection of the object posture, gesture, and/or further semantic properties may be presented via a separate codebook defined for each specific object type, e.g., upon the type of the object identified as a human, the known human gestures may be communicated via an index from a codebook defining different body postures and/or hand gestures of a human.

In at least some implementations, an indication of the type of the sensing information outcome can be accompanied with the indicating of accuracy value(s), e.g., estimation error for 3D position and/or along a specific direction, the velocity estimation error along a specific direction, etc.

In at least some implementations, an indication of a second type of the processing and/or computation outcome includes a criterion based on the outcome of a first processing and/or computation outcome, according to which the sensing Rx is requested to generate the second type of processing outcome upon the determination that the first processing outcome satisfies the indicated criteria. An example includes, but is not limited to, a sensing Rx being configured to estimate the position and/or velocity of a detected object of interest or a combination thereof, once an object of interest is detected as being present with a probability more than 0.9 within an indicated area of interest.

In at least some implementations, a sensing Rx performs a sensing measurement and processing to obtain one set of object features, and subsequently uses the obtained sensing outcome for the calculating of a remaining sensing parameter. For instance, the calculating of a remaining sensing parameter can be subject to a condition based on the indicated criteria and the previously obtained sensing outcome. In at least some implementations, the sensing Rx utilizes a posterior probability mass function of the object position and/or object presence for the calculation of the object velocity, such as where the object velocity calculation is conditioned on the object being within an indicated area of interest. In an alternative or additional implementation, the sensing Rx obtains a coarse estimate of a sensing parameter (e.g., object position), and if an indicated criterion is met on the obtained coarse estimate (e.g., a pedestrian coarse position is close to a sensitive area of a road crossing), and the sensing Rx performs a more precise processing to obtain the specified sensing information, e.g., more accurate positioning or obtaining a velocity/velocity direction estimate of the pedestrian.

The third configuration for the transmission of a report from the performed sensing processing such as described above may include one or more of:
a) A set of time and/or frequency and beam resources for the transmission of the generated report by the sensing Rx node;
b) A criteria for the transmission of the report, such as based on the generated processing outcomes, e.g., whether the object is detected to be present with at least an indicated probability, and/or if a measured received RS power is above a threshold;
c) Type(s) of the information included in the generated report, which may include all or a subset of the indicated processing and/or computation outcomes.

In at least some implementations, any of the described configurations (e.g., the said first, second, and/or third configurations described above) and the measurement and/or report or a subset thereof can be communicated between the sensing Rx and the network and/or sensing controller entity via the uplink (UL), downlink (DL) or sidelink (SL) physical data and/or control channels defined within the communication network, e.g., NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH), etc. Further, one or multiple of the configurations or part of information elements thereof can be communicated via RRC and/or higher-layer signaling. In at least some implementations, one or multiple of the configurations and/or part of information elements thereof can be communicated between the network and the sensing Rx node via a sensing Rx node-specific downlink control information (DCI), a group-common DCI, a broadcast message, and/or a multicast message.

In at least some implementations, different configurations and/or different information elements within one configuration can be communicated via different signaling. For instance, resources for sensing RS and/or the information elements containing the a priori known features of the object and/or scenario of interest may be indicated via the RRC and/or higher-layer signaling, whereas the activation of the sensing operation and type of the processing outcome may be defined dynamically via the sensing Rx node-specific DCI (e.g., on the PDCCH), a group common DCI, and/or a MAC-control element (CE). Further, one or multiple of the configurations and/or part of information elements thereof can be communicated via NAS signaling exchange between a sensing controller as a core network entity and the sensing Rx.

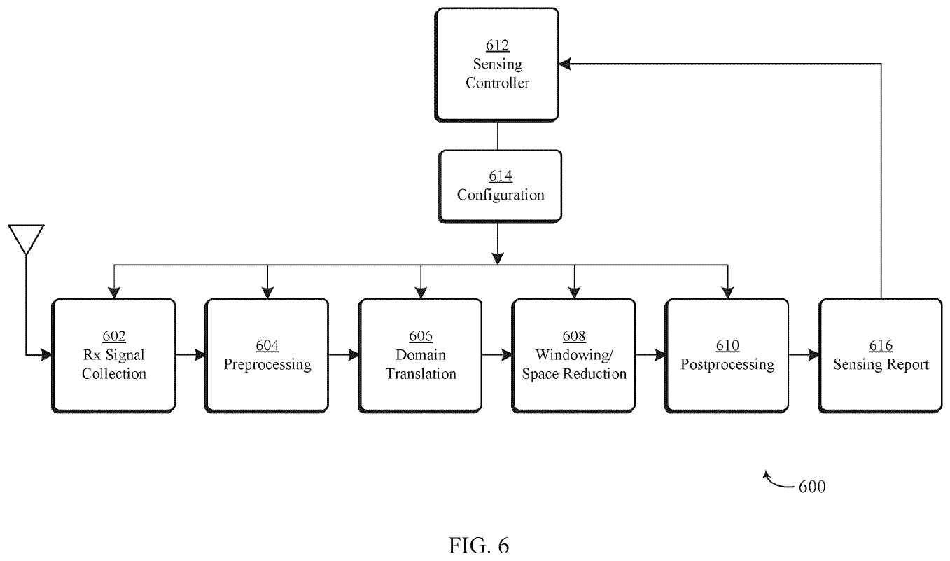

FIG. 6 illustrates a system 600 for radio sensing that supports configuration for radio sensing in accordance with aspects of the present disclosure. Implementations described herein, for instance, can further provide a priori-known feature utilization via CSI domain translation-reduction steps. The system 600, for example, includes sensing Rx signal processing to adjust a requested radio sensing outcome to the indicated features of the object and/or scenario of interest for radio sensing. The system 600 can be implemented by a sensing Rx and can include one or multiple of the following processing blocks:
1. Rx signal collection block 602: The received sensing RS transmitted by the sensing Tx node, together with other signals of relevance to the sensing processing, is received by the sensing Rx, quantized and/or compressed by the sensing Rx node, and stored in the memory by the sensing Rx node, according to the received configurations from the sensing controller and/or as part of the implementation and/or determination of the sensing Rx node;
2. Preprocessing block 604: output of the of the Rx signal collection block 602 may be utilized at the preprocessing block 604 to perform one or more of:
   a. Noise and/or interference reduction, e.g., a received interfering signal (e.g., a data channel, control channel, or another RS) is estimated and/or decoded and subtracted from the received sensing RS signal at the sensing Rx node;
   b. The received sensing RS may be interpolated over a resource plane defined via the sensing RS according to the received configurations, and/or over any transformed domain, to generate a comprehensive resource plane over which CSI and/or domain calculations may be implemented.

All or part of the elements of the preprocessing block 604 may be implemented according to the received configurations from the sensing controller and/or as part of the implementation/determination of the sensing Rx node;
3. Domain translation block 606: Stored and filtered sensing RS (e.g., output of the preprocessing block 604) can be treated as an RS for CSI estimation in an identified domain (or multiple identified domains), according to the nature of the specified sensing task and/or processing outcome, as well as the sensing Rx node capability, computation capability, and/or storage resource availability. The determination of a choice of the identified domain can be done via an indication included within the received configuration from the sensing controller and/or as part of the implementation and/or determination of the sensing Rx node based on the received configurations;
4. Windowing/space reduction block 608: The computed CSI data within the domain from the output of the domain translation block 606 can be filtered out to maintain a part of the computed CSI information relevant to the object and/or scenario of interest as indicated via the received configurations or is windowed to perform weighting on the calculated CSI values. For instance, the windowing/space reduction block 608 extracts the CSI components and/or received RS power within a relevant delay-doppler-angular region as configured or inferred from the a priori-known features of the object of interest for sensing, according to the received information.
5. Postprocessing block 610: The windowed/filtered CSI data in the relevant domain obtained from windowing/space reduction block 608 can be utilized to obtain the specified sensing processing output, e.g., by performing quantization and/or compression, detection and/or sensing of features of an object of interest, parameter estimation of an object of interest, etc. The sensing processing outcome can be selected according to the received configuration from the sensing controller, e.g., a network node, a third-party application on the sensing Rx device, etc.

While the blocks 602-610 are depicted as separate processing blocks, it is to be appreciated that operations discussed with reference to the different blocks may be combined.

Further to the system 600, a sensing controller 612 can perform configuration 614 to configure operation the different processing blocks, such as via configuration information transmitted to the sensing Rx that specifies processing logic and operations to be performed such as described above. Further, the sensing Rx can transmit a sensing report 616, such as to the sensing controller 612. The sensing report 616, for example, includes output from the postprocessing block 610 and/or other blocks described in the system 600.

According to one or more implementations, elements used to implement the blocks 602-610 or a combination and/or a subset of the steps above may be determined explicitly or implicitly from the configuration 614 from the sensing controller 612 and/or determined locally on the sensing Rx utilizing the configuration 614 as well as the locally available information at the sensing Rx node. Examples of such elements include sensing Rx location, sensing Tx location, statistical data, sensing history of the measured parameters, specified sensing quality-of-service (e.g., latency, accuracy), real-time capability of the sensing Rx node for performing a sensing task, etc.

In at least some implementations, a domain over which CSI data is to be measured and/or calculated may include one or more of:
a) Delay domain, such as components of the CSI (e.g., received sensing RS power, CSI matrix or a transformation thereof) for different delay values, according to a known and/or shared time-reference between the sensing Tx and the sensing Rx nodes;
b) Angular-azimuth domain, such as components of the CSI (e.g., received sensing RS power, CSI matrix or a transformation thereof) for different values of azimuth angle of arrival, according to a global, local, and/or known coordinate system;
c) Angular-elevation and/or zenith domain, such as components of the CSI (e.g., received sensing RS power, CSI matrix or a transformation thereof) for different values of elevation and/or zenith angle of arrival, according to a global, local, and/or known coordinate system;
d) Channel and/or CSI periodogram, where the periodograms are measured and/or presented in time, frequency, and/or jointly in time and frequency;
e) Doppler domain, such as components of the CSI (e.g., received sensing RS power, CSI matrix or a transformation thereof) for different values of doppler shift, according to a known reference for the sensing Rx node;
f) Orbital angular momentum (OAM) modes, such as components of the CSI (e.g., received sensing RS power, CSI matrix or a transformation thereof) for different received OAM modes;
g) Combinations of the above, including (but not limited to) angular-elevation domain, angular-azimuth domain, power-delay profile, angular power spectrum, angular power-delay spectrum, delay-doppler domain, doppler-power spectrum, angular delay-doppler profile, etc.

In at least some implementations, a priori-known features to be inferred and used in the sensing Rx node to implement all or any of the above steps may include one or more of:
a) Angle (e.g., azimuth, elevation, and/or zenith) of arrival for the sensing RS reflected from an object of interest and received by the sensing Rx node, a range of potential angles, and/or a mass probability function over the multiple range of angles, such as according to a known (e.g., to a sensing Rx), global, and/or local coordinate system;
b) Delay and/or ToF of arrival for sensing RS reflected from an object of interest and received by the sensing Rx node, a range of potential delays, or a mass probability function over the multiple range of delay, such as according to a known (e.g., to a sensing Rx) time-reference;
c) Doppler shift experienced by the sensing RS reflected from an object of interest and received by the sensing Rx node, a range of potential doppler shifts, and/or a mass probability function over the multiple range of doppler shifts;
d) Receive power from the sensing RS reflected from an object of interest and received by the sensing Rx node, a range of power values, a range of RCS values, and/or a mass probability function over the multiple range of power and/or RCS values, such as according to a known (e.g., to the sensing Rx) power-reference.

In at least some implementations, a sensing processing output (e.g., the sensing report 616) contains sensing information and is consumed locally, e.g., at a third party application located at the same sensing Rx node. Alternatively or additionally, the sensing processing output is transmitted to a node which consumes the generated sensing information and/or performs further processing on the generated sensing information. In alternative or additional implementations, the sensing processing output is generated and transmitted (e.g., according to the configurations received by the sensing controller 612) to a third network node (e.g., another network node with available computation resources, a mobile edge computing (MEC) node, and/or a UE node with available additional computational resources) where the sensing information can be further processed and/or combined and further sensing information extracted.

In at least some implementations the configuration of sensing information combining and/or further processing and/or transmitting a report thereof can be indicated by the sensing controller 612 to the third node via an available signaling interface between the sensing controller and the third node. Examples of the signaling interface include a non-access stratum (NAS) message between a core network function operating as a sensing controller and the third network node, via an UL, DL, and/or SL physical channel when the third node is a UE node, via backhaul adaptation protocol (BAP) and/or F1-interface for an integrated access and backhaul (IAB) node (e.g., the third node is a IAB node), side control signaling for a smart repeater, etc.

In at least some implementations the sensing controller 612 configures the sensing Rx with the blocks 602-610 or a subset and/or combination thereof, e.g., to compress the CSI measurements in the doppler-azimuth-delay domain within a specific range of doppler azimuth-delay, and to send the compressed measurement to the configured third node for further processing. The third node can receive the configuration of the type of the performed processing at the sensing Rx (e.g., via a similar configuration for sensing measurement as received by the sensing Rx node) and the third node can perform combining of the received sensing information from one or multiple sensing Rx nodes and extract the sensing information according to the received configuration. The type of the sensing information to be extracted by the processing node can be received via a configuration including one or multiple of the information elements as defined via the type of the processing and/or computation outcome such as discussed above.

Further to implementations discussed herein, the configuration of RSRP, RSRQ, RSSI, and rank indicator (RI) measurements is accompanied with the configuration of one or more permissibility conditions, according to which the received RS and/or signal power can be measured for the calculation of above metrics within the permissible domain and then used in the calculation of the RSRP, RSRQ, RSSI, RI metrics. As such, channel rank can be calculated within channel paths which are within the one or more permissibility conditions. The permissibility conditions may include, but not limited to:
a) Rx signal and/or RS (e.g., sensing RS) received within a specified angular range (e.g., azimuth and/or elevation) according to a global and/or known coordinate system at the receiver (e.g., sensing Rx) node;
b) RS (e.g., sensing RS) received within a specific delay margin experienced from the transmission until reception by the sensing Rx node, measured according to a known time reference to the sensing Rx node. The time reference, for instance, represents a similar or shared time reference between the sensing Rx node and the sensing Tx node when the sensing Rx node and sensing Tx node are time-synchronized and/or a delay margin with respect to the sensing Rx node time reference (e.g., received symbol, slot, subframe, and/or frame boundary) determined based on tracking the sensing Tx node transmissions such as synchronization signal block (SSB) and CSI-RS for tracking;
c) RS (e.g., sensing RS) received within a specific doppler shift margin measured according to a known frequency reference to the receiver. The frequency reference, for example, represents a similar and/or shared frequency reference between the sensing Rx node and the sensing Tx node and/or doppler shift margin with respect to the sensing Rx node frequency reference determined based on frequency tracking and synchronization with the sensing Tx node transmissions such as SSB and CSI-RS for tracking.

In at least one implementation, the channel rank measured within a specific delay range is smaller than that of the unconditioned channel rank, e.g., since the reflections outside of the said permissible range are excluded from the determination of the channel rank. In at least one implementation, a condition may be constructed via the multiple instances of the above conditions via a union, intersection, or a combination thereof. As such, an example permissibility condition may be constructed as, for example, measurement of the RS power received from:
[−10 10] OR [30 35] elevation degrees at the sensing Rx (according to a known coordinated system); and
within the delay margin of 1-2 ms from the transmission from the sensing Tx, where the time-reference at the transmitter is also known at the receiver.

In at least some implementations, the domain and domain-reduction elements discussed above can be used to define the permissibility conditions, e.g., RS power received from a portion of a wireless channel defined via a segment of a defined domain.

In at least some implementations, indication of the second configuration discussed above for the receiver signal processing and/or measurements of the received sensing RS includes an indication of a measurement threshold value for the determination of a sensing outcome. The threshold, for instance, is jointly indicated with a measurement type, measurement domain, a range within the said measurement domain, measurement permissibility condition, and/or combinations thereof. Further, an energy threshold can be indicated for determination of an object presence, such as to be measured over indicated time and frequency resources and an indicated angular range. In at least some implementations, the energy threshold is to be applied on an indicated conditional CSI measurement, e.g., RSRP measurement above the indicated threshold within the elevation angular range of [10 30] degrees with respect to a local coordinate system at the UE indicating presence of an object.

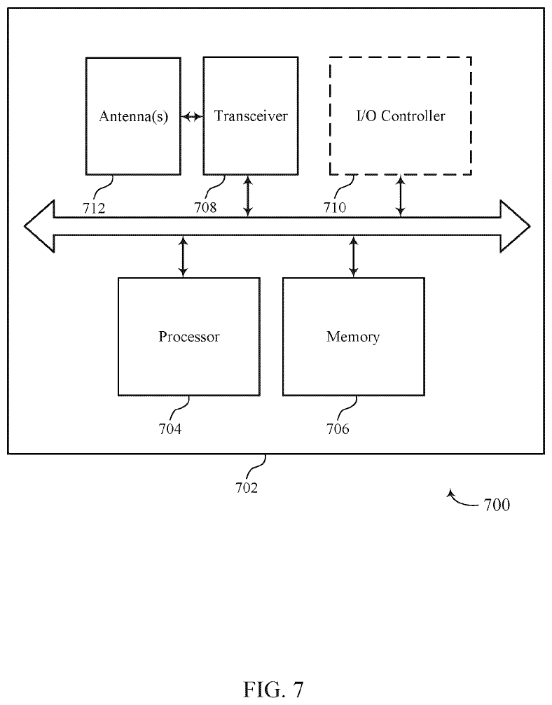

FIG. 7 illustrates an example of a block diagram 700 of a device 702 (e.g., an apparatus) that supports configuration for radio sensing in accordance with aspects of the present disclosure. The device 702 may be an example of a network entity 102 and/or UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to receive a first indication of one or more feature characteristics of one or more objects; receive one or more reference signals; perform radio sensing of an environment based at least in part on the one or more reference signals and the one or more feature characteristics of the one or more objects; and transmit a second indication based at least in part on the radio sensing.

Further, in some implementations, the processor 704 and/or the transceiver 708 may be configured as and/or otherwise support a means to: receive the first indication from a first device, and the one or more reference signals from a second, different device; receive the first indication and the one or more reference signals from a same device; the one or more feature characteristics of the one or more objects include at least one of: presence information for the one or more objects; location information for the one or more objects; velocity information for the one or more objects; RCS for the one or more objects; types of the one or more objects; at least one of shape or posture of the one or more objects; at least one of composite or texture of the one or more objects; or a perceived CSI description at a sensing receiver node including an effect of the one or more objects, the perceived CSI description includes at least one of a CSI domain or a CSI domain segment; the CSI domain includes at least one of: delay domain; angular-azimuth domain; one or more of angular-elevation or zenith domain; one or more of channel or CSI periodogram; or doppler domain.

Further, in some implementations, the processor 704 and/or the transceiver 708 may be configured as and/or otherwise support a means to: the one or more feature characteristics of the one or more objects are identified in the first indication via one or more indices that correspond to a first table that includes different predefined feature values for different feature characteristics of the one or more objects; the first table includes a first index value that corresponds to a first set of feature characteristics and a second index value that corresponds to a second set of feature characteristics, the first set of feature characteristics and the second set of feature characteristics include at least one common feature characteristic; the one or more feature characteristics of the one or more objects are further identified in the first indication via one or more indices that correspond to a second table that includes predefined feature values for different feature characteristics of the one or more objects.

Further, in some implementations, the processor 704 and/or the transceiver 708 may be configured as and/or otherwise support a means to: receive reference signal information for the one or more reference signals, the reference signal information including at least one of: one or more of a waveform type or a set of waveform-defining parameters for a waveform used to transmit the one or more reference signals; a set of resources over which the one or more reference signals are transmitted according to the waveform; one or more of a transmit beam pattern or a radio pattern over which the one or more reference signals are transmitted; a transmit power used to transmit the one or more reference signals; a sequence generation and physical-resource-mapping type used to generate the one or more reference signals; or a location of a device that transmits the one or more reference signals; receive sensing configuration information for the radio sensing, the sensing configuration information including at least one of: an indication of one or more receive spatial filters to be used for reception of the one or more reference signals; an indication of one or more known attributes of the one or more feature characteristics of the environment; or one or more types of output to be provided based on the radio sensing; and perform the radio sensing further based on the sensing configuration information.

Further, in some implementations, the processor 704 and/or the transceiver 708 may be configured as and/or otherwise support a means to: receive the first indication via a first signaling type; and receive the sensing configuration information via a second, different signaling type; the one or more types of output to be provided based on the radio sensing includes at least one of: one or more of quantized received reference signals or compressed reference signals; CSI measurements obtained from the received reference signals; inference of a presence of the one or more objects; estimated location of the one or more objects; estimated velocity of the one or more objects; estimated RCS of the one or more objects; estimation of one or more of type, shape, composite, or posture of the one or more objects; an indication of a sensing quality of service of the radio sensing; or combinations thereof; the one or more types of output to be provided based on the radio sensing are indicated via one or more indices that correspond to a table that includes different types of output to be provided based on radio sensing.

Further, in some implementations, the processor 704 and/or the transceiver 708 may be configured as and/or otherwise support a means to: the one or more types of output to be provided based on the radio sensing is indicated via one or more indices that correspond to a table that includes different output values for different types of output to be provided based on radio sensing; the CSI measurements include at least one of: a CSI domain; one or more of a segment or a margin within the CSI domain; or an operation to be performed over the CSI measurements within the indicated one or more of the segment or margin; the CSI domain includes at least one of: delay domain; angular-azimuth domain; one or more of angular-elevation or zenith domain; one or more of channel or CSI periodogram; or doppler domain; the one or more feature characteristics of the one or more objects are identified in the first indication via one or more indices that correspond to a first table that includes different predefined feature values for different feature characteristics of the one or more objects, and the second indication identifies output of the radio sensing via one or more indices that correspond to the first table; the CSI measurements include, for the one or more feature characteristics, at least one of: CSI measurements on an intersection of the one or more feature characteristics; CSI measurements on a union of the one or more feature characteristics; or a combination thereof; receive the first indication via one or more of higher layer signaling or defined physical channels of a communication network; transmit the second indication based on at least one of: a set of time, frequency, and beam resources for transmission of the second indication; at least one criterion for the transmission of the second indication; or a type of information included in the second indication.

In a further example, the processor 704 and/or the transceiver 708 may support wireless communication at the device 702 in accordance with examples as disclosed herein. The processor 704 and/or the transceiver 708, for instance, may be configured as or otherwise support a means to transmit a first indication of one or more feature characteristics of one or more objects; transmit one or more reference signals; and receive a second indication of a result of radio sensing performed based at least in part on the transmitted one or more reference signals.

Further, in some implementations, the one or more feature characteristics of the one or more objects include at least one of: presence information for the one or more objects; location information for the one or more objects; velocity information for the one or more objects; RCS for the one or more objects; types of the one or more objects; at least one of shape or posture of the one or more objects; at least one of composite or texture of the one or more objects; or a perceived CSI description at a sensing receiver node including an effect of the one or more objects, the perceived CSI description includes at least one of a CSI domain or a CSI domain segment; the CSI domain includes at least one of: delay domain; angular-azimuth domain; one or more of angular-elevation or zenith domain; one or more of channel or CSI periodogram; or doppler domain; the one or more feature characteristics of the one or more objects are identified in the first indication via one or more indices that correspond to a first table that includes different predefined feature values for different feature characteristics of the one or more objects; the first table includes a first index value that corresponds to a first set of feature characteristics and a second index value that corresponds to a second set of feature characteristics, the first set of feature characteristics and the second set of feature characteristics include at least one common feature characteristic

Further, in some implementations, the one or more feature characteristics of the one or more objects are further identified in the first indication via one or more indices that correspond to a second table that includes predefined features values for different feature characteristics of the one or more objects; transmit reference signal information for the one or more reference signals, the reference signal information including at least one of: one or more of a waveform type or a set of waveform-defining parameters for a waveform used to transmit the one or more reference signals; a set of resources over which the one or more reference signals are transmitted according to the waveform; one or more of a transmit beam pattern or a radio pattern over which the one or more reference signals are transmitted; a transmit power used to transmit the one or more reference signals; a sequence generation and physical-resource-mapping type used to generate the one or more reference signals; or a location of a device that transmits the one or more reference signals.

Further, in some implementations, the processor and the transceiver are configured to cause the apparatus to transmit sensing configuration information for the radio sensing, the sensing configuration information including at least one of: an indication of one or more receive spatial filters to be used for a reception of the one or more reference signals; an indication of one or more known attributes of the one or more feature characteristics of the one or more objects; or one or more types of output to be provided based on the radio sensing; transmit the first indication via a first signaling type; and transmit the sensing configuration information via a second, different signaling type; the one or more types of output to be provided based on the radio sensing includes at least one of: one or more of quantized received reference signals or compressed reference signals; CSI measurements for the reference signals; inference of a presence of the one or more objects; estimated location of the one or more objects; estimated velocity of the one or more objects; estimated RCS of the one or more objects; estimation of one or more of type, shape, composite, or posture of the one or more objects; an indication of a sensing quality of service of the radio sensing; or combinations thereof.

Further, in some implementations, the one or more types of output to be provided based on the radio sensing are indicated via one or more indices that correspond to a table that includes different types of output to be provided based on radio sensing; the one or more types of output to be provided based on the radio sensing is indicated via one or more indices that correspond to a table that includes different output values for different types of output to be provided based on radio sensing; the CSI measurements include at least one of: a CSI domain; one or more of a segment or a margin within the CSI domain; or an operation to be performed over the CSI measurements within the indicated one or more of the segment or margin; the CSI domain includes at least one of: delay domain; angular-azimuth domain; one or more of angular-elevation or zenith domain; one or more of channel or CSI periodogram; or doppler domain; the one or more feature characteristics of the one or more objects are identified in the first indication via one or more indices that correspond to a first table that includes different predefined feature values for different feature characteristics of the one or more objects, and the second indication identifies output of the radio sensing via one or more indices the correspond to the first table; the CSI measurements include, for the one or more feature characteristics, at least one of: CSI measurements on an intersection of the one or more feature characteristics; CSI measurements on a union of the one or more feature characteristics; or a combination thereof; transmit the first indication via one or more of higher layer signaling or defined physical channels of a communication network; transmit a third indication including at least one of: a set of time, frequency, and beam resources for transmission of the second indication; at least one criterion for the transmission of the second indication; or a type of information included in the second indication.

In a further example, the processor 704 and/or the transceiver 708 may support wireless communication at the device 702 in accordance with examples as disclosed herein. The processor 704 and/or the transceiver 708, for instance, may be configured as or otherwise support a means to receive radio sensing measurements of an environment; receive processing configuration information for a processing configuration used to generate the radio sensing measurements; extract, from the radio sensing measurements and based at least in part on the processing configuration information, sensing information for the environment; and transmit a report based on the extracted sensing information for the environment.

Further, in some implementations, the processor and the transceiver are configured to cause the apparatus to receive the radio sensing measurements from multiple devices and combine at least some of the radio sensing measurements from the multiple devices to extract the sensing information for the environment; receive one or more feature characteristics of one or more objects, and extract the sensing information further based at least in part on the one or more feature characteristics of the one or more objects; receive the radio sensing measurements of the environment from a first device and receive the processing configuration information from a second, different device; receive the radio sensing measurements of the environment and the processing configuration information from a same device; where the processing configuration information includes at least one of: preprocessing applied to the radio sensing measurements; domain translation applied to the radio sensing measurements; windowing applied to the radio sensing measurements; space reduction applied to the radio sensing measurements; or postprocessing applied to the radio sensing measurements; where the sensing information includes attributes of one or more objects detected in the environment.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

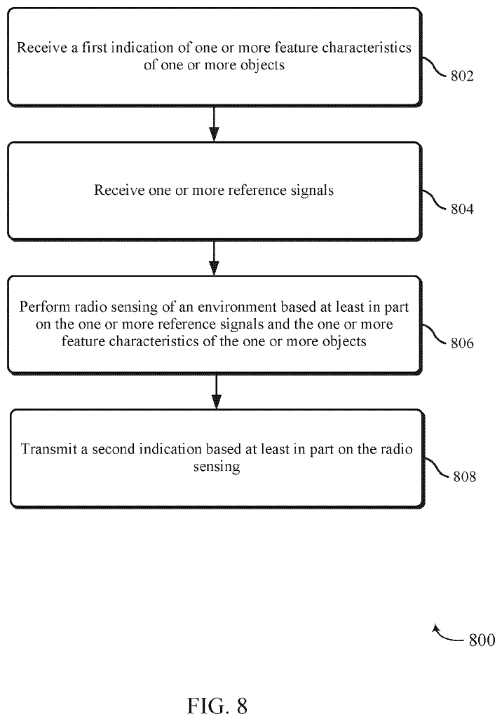

FIG. 8 illustrates a flowchart of a method 800 that supports configuration for radio sensing in accordance with aspects of the present disclosure. The operations of the method 800 may be implemented by a device or its components as described herein. For example, the operations of the method 800 may be performed by a network entity 102 and/or a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first indication of one or more feature characteristics of one or more objects. The operations of 802 may be performed in accordance with examples as described herein. In some implementations, aspects of the operations of 802 may be performed by a device as described with reference to FIG. 1.

At 804, the method may include receiving one or more reference signals. The operations of 804 may be performed in accordance with examples as described herein. In some implementations, aspects of the operations of 804 may be performed by a device as described with reference to FIG. 1.

At 806, the method may include performing radio sensing of an environment based at least in part on the one or more reference signals and the one or more feature characteristics of the one or more objects. The operations of 806 may be performed in accordance with examples as described herein. In some implementations, aspects of the operations of 806 may be performed by a device as described with reference to FIG. 1.

At 808, the method may include transmitting a second indication based at least in part on the radio sensing. The operations of 808 may be performed in accordance with examples as described herein. In some implementations, aspects of the operations of 808 may be performed by a device as described with reference to FIG. 1.

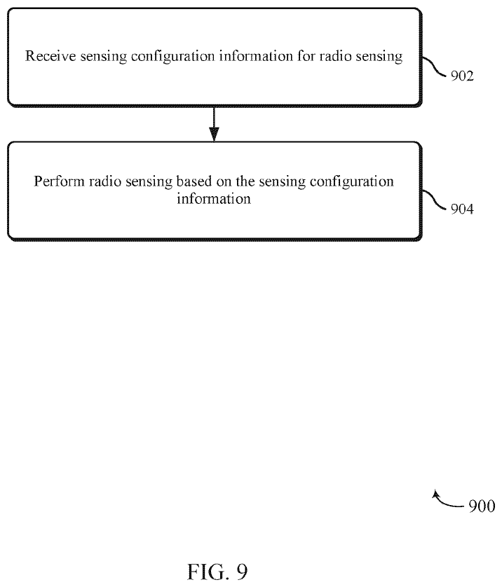

FIG. 9 illustrates a flowchart of a method 900 that supports configuration for radio sensing in accordance with aspects of the present disclosure. The operations of the method 900 may be implemented by a device or its components as described herein. For example, the operations of the method 900 may be performed by a network entity 102 and/or a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving sensing configuration information for radio sensing. The operations of 902 may be performed in accordance with examples as described herein. In some implementations, aspects of the operations of 902 may be performed by a device as described with reference to FIG. 1.

At 904, the method may include performing radio sensing based on the sensing configuration information. The operations of 904 may be performed in accordance with examples as described herein. In some implementations, aspects of the operations of 904 may be performed by a device as described with reference to FIG. 1.

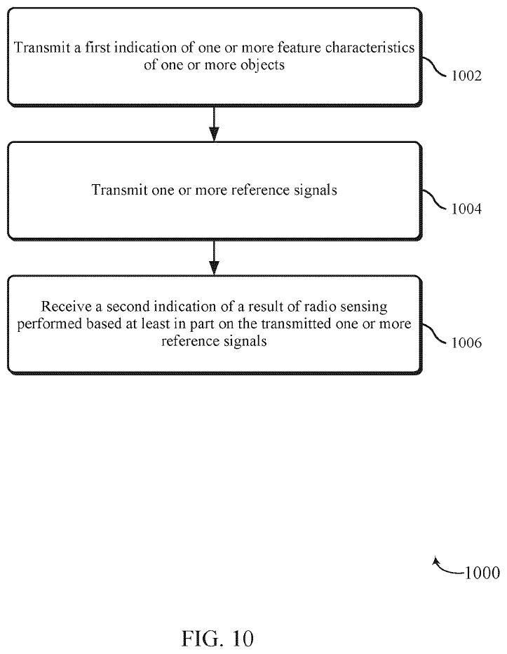

FIG. 10 illustrates a flowchart of a method 1000 that supports configuration for radio sensing in accordance with aspects of the present disclosure. The operations of the method 1000 may be implemented by a device or its components as described herein. For example, the operations of the method 1000 may be performed by a network entity 102 and/or a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting a first indication of one or more feature characteristics of one or more objects. The operations of 1002 may be performed in accordance with examples as described herein. In some implementations, aspects of the operations of 1002 may be performed by a device as described with reference to FIG. 1.

At 1004, the method may include transmitting one or more reference signals. The operations of 1004 may be performed in accordance with examples as described herein. In some implementations, aspects of the operations of 1004 may be performed by a device as described with reference to FIG. 1.

At 1006, the method may include receiving a second indication of a result of radio sensing performed based at least in part on the transmitted one or more reference signals. The operations of 1006 may be performed in accordance with examples as described herein. In some implementations, aspects of the operations of 1006 may be performed by a device as described with reference to FIG. 1.

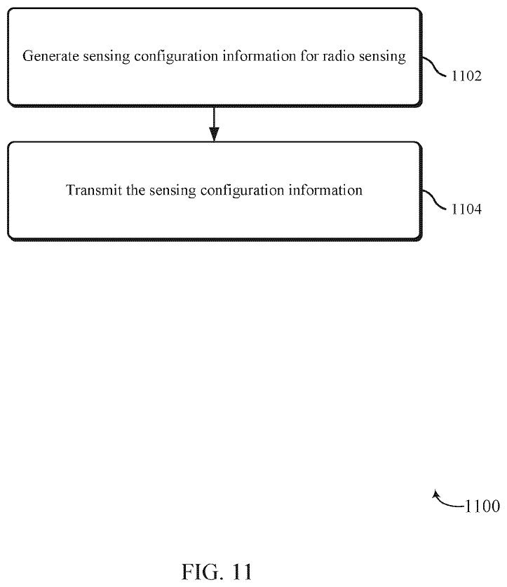

FIG. 11 illustrates a flowchart of a method 1100 that supports configuration for radio sensing in accordance with aspects of the present disclosure. The operations of the method 1100 may be implemented by a device or its components as described herein. For example, the operations of the method 1100 may be performed by a network entity 102 and/or a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include generating sensing configuration information for radio sensing. The operations of 1102 may be performed in accordance with examples as described herein. In some implementations, aspects of the operations of 1102 may be performed by a device as described with reference to FIG. 1.

At 1104, the method may include transmitting the sensing configuration information. The operations of 1104 may be performed in accordance with examples as described herein. In some implementations, aspects of the operations of 1104 may be performed by a device as described with reference to FIG. 1.

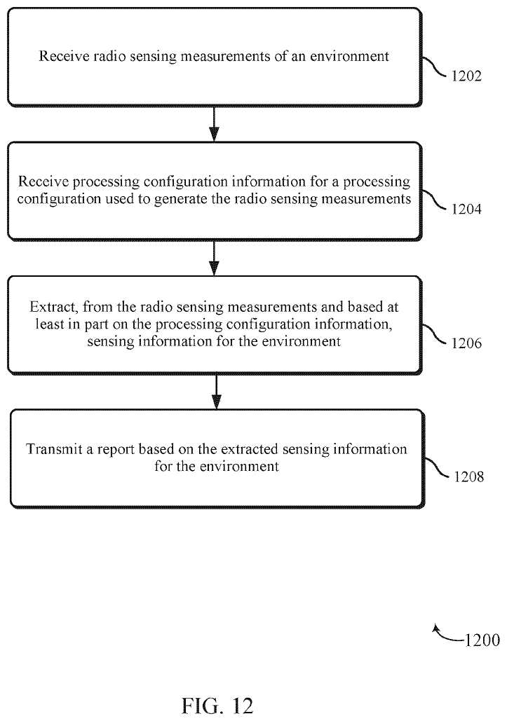

FIG. 12 illustrates a flowchart of a method 1200 that supports configuration for radio sensing in accordance with aspects of the present disclosure. The operations of the method 1200 may be implemented by a device or its components as described herein. For example, the operations of the method 1200 may be performed by a network entity 102 and/or a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include receiving radio sensing measurements of an environment. The operations of 1202 may be performed in accordance with examples as described herein. In some implementations, aspects of the operations of 1202 may be performed by a device as described with reference to FIG. 1.

At 1204, the method may include receiving processing configuration information for a processing configuration used to generate the radio sensing measurements. The operations of 1204 may be performed in accordance with examples as described herein. In some implementations, aspects of the operations of 1204 may be performed by a device as described with reference to FIG. 1.

At 1206, the method may include extracting, from the radio sensing measurements and based at least in part on the processing configuration information, sensing information for the environment. The operations of 1206 may be performed in accordance with examples as described herein. In some implementations, aspects of the operations of 1206 may be performed by a device as described with reference to FIG. 1.

At 1208, the method may include transmitting a report based on the extracted sensing information for the environment. The operations of 1208 may be performed in accordance with examples as described herein. In some implementations, aspects of the operations of 1208 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and configured to cause the apparatus to:
receive a first indication of one or more feature characteristics of one or more objects;
receive one or more reference signals;
perform radio sensing of an environment based at least in part on the one or more reference signals and the one or more feature characteristics of the one or more objects; and
transmit a second indication based at least in part on the radio sensing.

2. The apparatus of claim 1, wherein the one or more feature characteristics of the one or more objects comprise at least one of:
presence information for the one or more objects;
location information for the one or more objects;
velocity information for the one or more objects;
radar cross section (RCS) for the one or more objects;
types of the one or more objects;
at least one of shape or posture of the one or more objects;
at least one of composite or texture of the one or more objects; or
a perceived channel state information (CSI) description at a sensing receiver node including an effect of the one or more objects, wherein the perceived CSI description includes at least one of a CSI domain or a CSI domain segment.

3. The apparatus of claim 2, wherein the CSI domain comprises at least one of:
delay domain;
angular-azimuth domain;
one or more of angular-elevation or zenith domain;
one or more of channel or CSI periodogram; or
doppler domain.

4. The apparatus of claim 2, wherein the one or more feature characteristics of the one or more objects are identified in the first indication via one or more indices that correspond to a first table that includes different predefined feature values for different feature characteristics of the one or more objects.

5. The apparatus of claim 4, wherein the first table comprises a first index value that corresponds to a first set of feature characteristics and a second index value that corresponds to a second set of feature characteristics, wherein the first set of feature characteristics and the second set of feature characteristics include at least one common feature characteristic.

6. The apparatus of claim 1, wherein the at least one processor is configured to cause the apparatus to receive reference signal information for the one or more reference signals, the reference signal information comprising at least one of:
one or more of a waveform type or a set of waveform-defining parameters for a waveform used to transmit the one or more reference signals;
a set of resources over which the one or more reference signals are transmitted according to the waveform;
one or more of a transmit beam pattern or a radio pattern over which the one or more reference signals are transmitted;
a transmit power used to transmit the one or more reference signals;
a sequence generation and physical-resource-mapping type used to generate the one or more reference signals; or
a location of a device that transmits the one or more reference signals.

7. The apparatus of claim 1, wherein the at least one processor is configured to cause the apparatus to:
receive sensing configuration information for the radio sensing, the sensing configuration information comprising at least one of:
an indication of one or more receive spatial filters to be used for reception of the one or more reference signals;
an indication of one or more known attributes of the one or more feature characteristics of the environment; or
one or more types of output to be provided based on the radio sensing; and
perform the radio sensing further based on the sensing configuration information.

8. The apparatus of claim 7, wherein the at least one processor is configured to cause the apparatus to:
receive the first indication via a first signaling type; and
receive the sensing configuration information via a second, different signaling type.

9. The apparatus of claim 7, wherein the one or more types of output to be provided based on the radio sensing comprises at least one of:
one or more of quantized received reference signals or compressed reference signals;
channel state information (CSI) measurements obtained from the received one or more reference signals;
inference of a presence of the one or more objects;
estimated location of the one or more objects;
estimated velocity of the one or more objects;
estimated radar cross section (RCS) of the one or more objects;
estimation of one or more of type, shape, composite, or posture of the one or more objects;
an indication of a sensing quality of service of the radio sensing; or
combinations thereof.

10. The apparatus of claim 9, wherein the one or more types of output to be provided based on the radio sensing are indicated via one or more indices that correspond to a table that includes different types of output to be provided based on radio sensing.

11. The apparatus of claim 9, wherein the one or more types of output to be provided based on the radio sensing is indicated via one or more indices that correspond to a table that includes different output values for different types of output to be provided based on radio sensing.

12. The apparatus of claim 9, wherein the CSI measurements comprise at least one of:
a CSI domain;
one or more of a segment or a margin within the CSI domain; or
an operation to be performed over the CSI measurements within the one or more of the segment or the margin.

13. An apparatus comprising:
at least one memory; and
at least one processor coupled with the at least one memory and configured to cause the apparatus to:
transmit a first indication of one or more feature characteristics of one or more objects;
transmit one or more reference signals; and
receive a second indication of a result of radio sensing performed based at least in part on the transmitted one or more reference signals.

14. The apparatus of claim 13, wherein the one or more feature characteristics of the one or more objects comprise at least one of:
presence information for the one or more objects;
location information for the one or more objects;
velocity information for the one or more objects;
radar cross section (RCS) for the one or more objects;
types of the one or more objects;
at least one of shape or posture of the one or more objects;
at least one of composite or texture of the one or more objects; or
a perceived channel state information (CSI) description at a sensing receiver node including an effect of the one or more objects, wherein the perceived CSI description includes at least one of a CSI domain or a CSI domain segment.

15. The apparatus of claim 14, wherein the CSI domain comprises at least one of:
delay domain;
angular-azimuth domain;
one or more of angular-elevation or zenith domain;
one or more of channel or CSI periodogram; or
doppler domain.

16. The apparatus of claim 14, wherein the one or more feature characteristics of the one or more objects are identified in the first indication via one or more indices that correspond to a first table that includes different predefined feature values for different feature characteristics of the one or more objects.

17. The apparatus of claim 16, wherein the first table comprises a first index value that corresponds to a first set of feature characteristics and a second index value that corresponds to a second set of feature characteristics, wherein the first set of feature characteristics and the second set of feature characteristics include at least one common feature characteristic.

18. The apparatus of claim 16, wherein the one or more feature characteristics of the one or more objects are further identified in the first indication via one or more indices that correspond to a second table that includes predefined features values for different feature characteristics of the one or more objects.

19. An apparatus comprising:
at least one memory; and
at least one processor coupled with the at least one memory and configured to cause the apparatus to:
receive radio sensing measurements of an environment;
receive processing configuration information for a processing configuration used to generate the radio sensing measurements;
extract, from the radio sensing measurements and based at least in part on the processing configuration information, sensing information for the environment; and
transmit a report based on the extracted sensing information for the environment.

20. A processor for wireless communication, comprising:
at least one controller coupled with at least one memory and configured to cause the processor to:
receive a first indication of one or more feature characteristics of one or more objects;
receive one or more reference signals;
perform radio sensing of an environment based at least in part on the one or more reference signals and the one or more feature characteristics of the one or more objects; and
transmit a second indication based at least in part on the radio sensing.
